(19) United States
(12) Patent Application Publication
(10) Pub. No.: US 2025/0355722 A1
(43) Pub. Date: Nov. 20, 2025

(54) RESOURCE USAGE FORECASTING USING MACHINE LEARNING

(71) Applicant: SAP SE, Walldorf (DE)

(72) Inventor: Boyan Lyubomirov Blagoev, Sophia (BG)

(21) Appl. No.: 18/665,224

(22) Filed: May 15, 2024

(51) Int. Cl. G06F 9/50

(52) U.S. Cl. CPC G06F 9/5077; G06F 9/5016; G06F 9/5027; G06F 2209/501; G06F 2209/5019; G06F 2209/5022; G06F 2209/508

(57) ABSTRACT

As described herein, a machine learning model is used to accurately predict the future resource usage (e.g., memory usage, processor usage, network usage, and the like) of one or more applications and/or databases. By analyzing historical data and patterns, the machine learning model provides insights into the expected resource usage for a predetermined period of time (e.g., three days or seven days). The machine learning model may be optimized for time series forecasting. For example, the AutoARIMA or Theta algorithms may be used for training. A user interface may be provided that enables easy visualization of the forecasted resource usage. A predetermined threshold may be defined for one or more of the sources being forecast. For example, a threshold for memory usage may be set. If the predicted memory usage for any application or database exceeds the predetermined threshold, a notification is sent to one or more users.

### TECHNICAL FIELD

The subject matter disclosed herein generally relates to systems for forecasting resource usage of applications and databases and, more specifically, to systems utilizing machine learning to forecast resource usage of applications and databases.

### BACKGROUND

Applications and databases consume varying amounts of resources (e.g., processor cycles, memory, network bandwidth, disk space, and the like) over time. When an application or database needs additional resources, the additional resources may be requested from an operating system or data center control system. In response, the additional resources may be allocated, ensuring smooth operations. However, the additional resources may not be available, impacting performance.

### BRIEF DESCRIPTION OF THE DRAWINGS

FIG. 1 shows a network diagram illustrating an example network environment suitable for resource usage forecasting using machine learning.

FIG. 2 shows a block diagram of a forecast server, suitable for resource usage forecasting using machine learning.

FIG. 3 is a block diagram of a neural network, suitable for use as a machine learning model for forecasting resource usage, according to some example embodiments.

FIG. 4 shows an illustration of an example database schema, suitable for training models suitable for forecasting resource usage.

FIG. 5 shows an illustration of an example database schema, suitable for storing resource usage forecasts generated using machine learning.

FIG. 6 shows a flowchart illustrating a method of resource usage forecasting using machine learning.

FIG. 7 shows an illustration of an example user interface for displaying resource usage forecasts.

FIG. 8 shows a block diagram showing one example of a software architecture for a computing device.

FIG. 9 shows a block diagram of a machine in the example form of a computer system within which instructions may be executed for causing the machine to perform any one or more of the methodologies discussed herein.

### DETAILED DESCRIPTION

Example methods and systems are directed to forecasting resource usage using machine learning. As described herein, a machine learning model is used to accurately predict the future resource usage (e.g., memory usage, processor usage, network usage, and the like) of one or more applications and/or databases. By analyzing historical data and patterns, the machine learning model provides insights into the expected resource usage for a predetermined period of time (e.g., three days or seven days).

The machine learning model may be optimized for time series forecasting. For example, the AutoARIMA, Theta, or error trend and seasonality (ETS) algorithms may be used for training. A user interface may be provided that enables easy visualization of the forecasted resource usage. In some example embodiments, a JavaScript frontend is used that provides interactive charts that allow users to easily understand and interpret the predicted resource usage.

A predetermined threshold may be defined for one or more of the sources being forecast. For example, a threshold for memory usage may be set. If the predicted memory usage for any application or database (collectively, “software”) exceeds the predetermined threshold, a notification is sent to one or more users. This enables a recipient of the notification to quickly respond to the excessive memory usage. For example, the user may restart the software, allocate additional memory to the software, notify developers of the software of a possible bug in the software, or any suitable combination thereof.

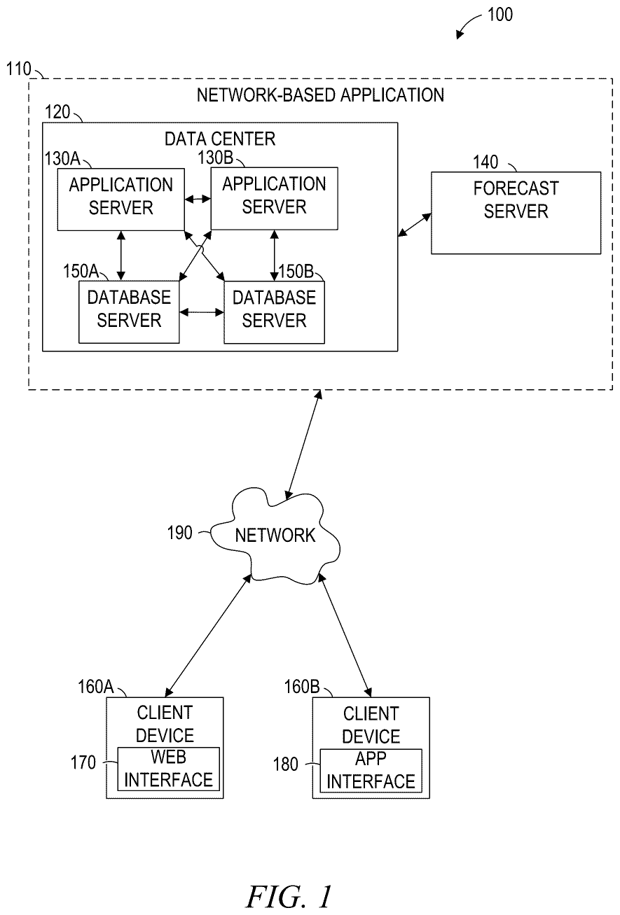

FIG. 1 shows a network diagram illustrating an example network environment 100 suitable for resource usage forecasting using machine learning. The network environment 100 includes a network-based application 110, client devices 160A and 160B, and a network 190. The network-based application 110 is implemented at a data center 120 comprising application servers 130A and 130B in communication with database servers 150A and 150B. An application executing on the application servers 130A-130B may access data from the database servers 150A-150B. The letter suffixes of reference numbers may be omitted when doing so does not raise ambiguity. For example, the application servers 130A-130B may be referred to collectively as “application servers 130.” Similarly, when the specific one of the application servers 130A-130B is not of particular import, “application server 130” may be referenced.

The forecast server 140 may use historical resource usage data for the applications and databases of the data center 120 to forecast future resource usage of the applications and databases. An administrator of the data center 120 may use the forecast resource usage information to allocate resources of the data center 120 to the applications and databases. In some example embodiments, the forecast server 140 is part of the data center 120.

An administrator of the data center 120 may receive notifications of resource usage forecasts via the web interface 170 or the app interface 180 of forecast server 140. The forecast server 140 may include a machine learning model trained on historical support resource usage data stored in log files of the application servers 130A-130B or database tables of the database servers 150A-150B. Once trained, the machine learning model may be used by the forecast server 140 to predict future resource usage of the applications and databases.

The application running on the application server 130 may provide services to the client devices 160A and 160B. For example, a user of the client device 160A may be an employee of a business using a business application. The user may use the services to generate invoices, manage employees, develop other applications, or any suitable combination thereof. The user interface for the application may be presented using a web interface 170 or an app interface 180.

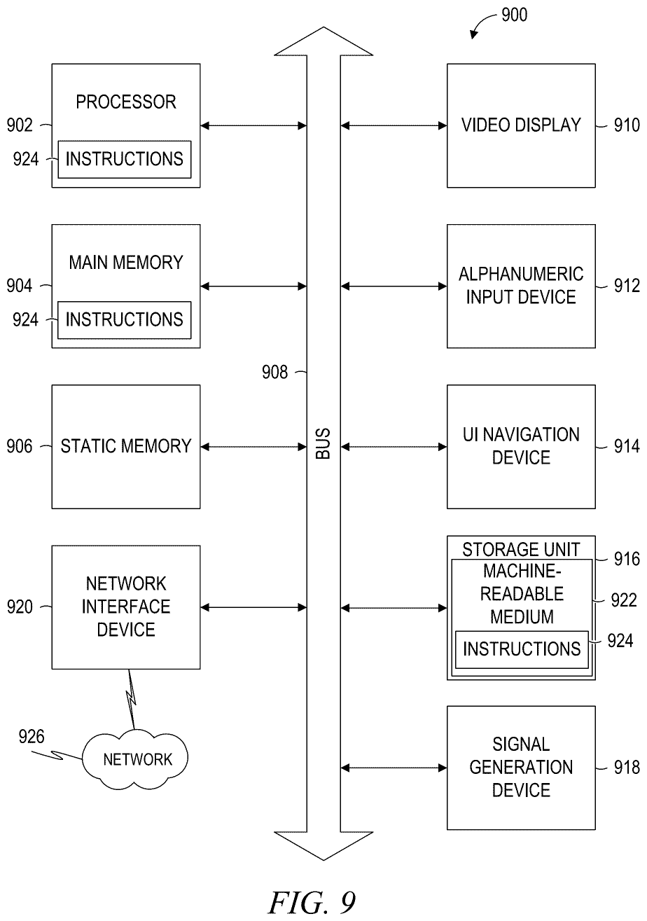

The application servers 130A-130B, the forecast server 140, the database servers 150A-150B, and the client devices 160A-160B may each be implemented in a computer system, in whole or in part, as described below with respect to FIG. 9. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130B, the forecast server 140, the database servers 150A-150B, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one forecast server 140, two application servers 130A-130B, two client devices 160A and 160B, and the like), any number of each element is contemplated. For example, the application server 130A may be one of dozens or hundreds of active and standby servers and provide services to millions of client devices. Likewise, the forecast server 140 may access data from dozens or hundreds of database servers and file servers, be used by many application servers 130, and so on.

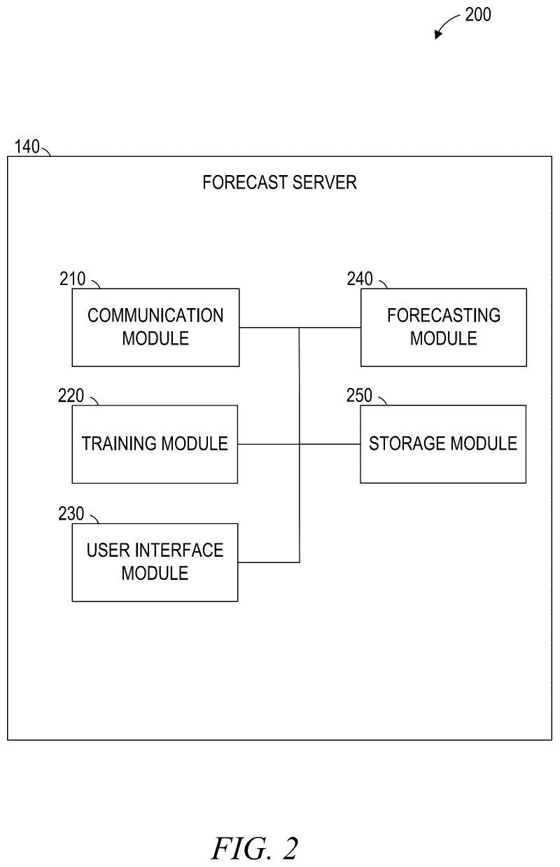

FIG. 2 shows a block diagram 200 of the forecast server 140, suitable for resource usage forecasting using machine learning. The forecast server 140 is shown as including a communication module 210, a training module 220, a user interface module 230, a forecasting module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the forecast server 140 and transmits data from the forecast server 140. For example, the communication module 210 may receive, from the database server 150A, historical resource usage data for an application. In response, the communication module 210 provides the support ticket to the forecasting module 240. The communication module 210 may also send requests to the database servers 150 for training data to be used by the training module 220.

The training module 220 trains a machine-learning model of the forecasting module 240. The training includes providing a training set of historical resource usage data to the machine-learning model. For example, the trained machine learning model may be generated by providing a training set comprising historical resource usage data for a plurality of applications and databases.

The forecasting module 240 determines, for an application or a database and based on historical resource usage data for the application or database, a forecast of resource usage by the application or database. The forecasting module 240 may use a machine learning model such as AutoARIMA, Theta, or ETS.

Data, metadata, documents, instructions, or any suitable combination thereof may be stored and accessed by the storage module 250. For example, local storage of the forecast server 140, such as a hard drive, may be used. As another example, network storage may be accessed by the storage module 250 via the network 190.

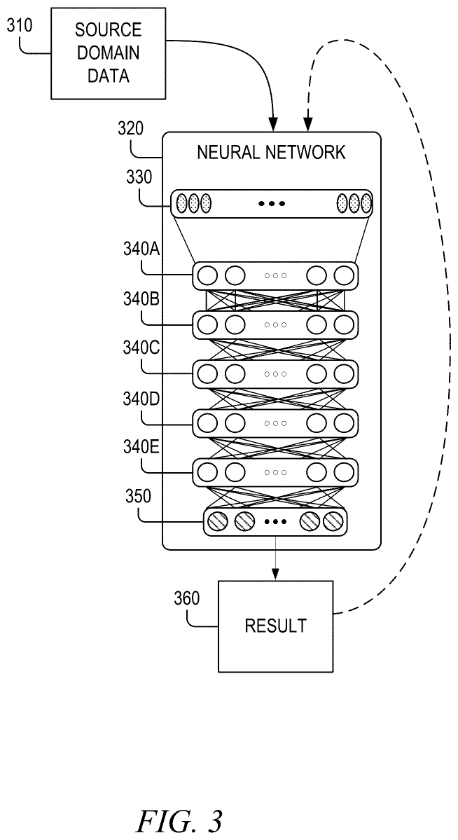

FIG. 3 is a block diagram of a neural network 320, suitable for use as a machine learning model for forecasting resource usage, according to some example embodiments. The neural network 320 takes source domain data 310 as input and processes the source domain data 310 using an input layer 330; intermediate, hidden layers 340A, 340B, 340C, 340D, and 340E; and output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between one and the size of the training dataset, and the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model, satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network (CNN), a recurrent neural network, a transformer neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value, which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like. With the help of natural language processing (NLP) and advanced data pre-processing, a machine learning model (e.g., the neural network 320) can be trained on historical (existing) data (for instance, resource usage data) from the system to predict future data.

The transformer architecture processes an entire input at once rather than sequentially. For example, a recurrent neural network (RNN) processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating artificial intelligence, and the like) being provided as an input for determination of the next result.

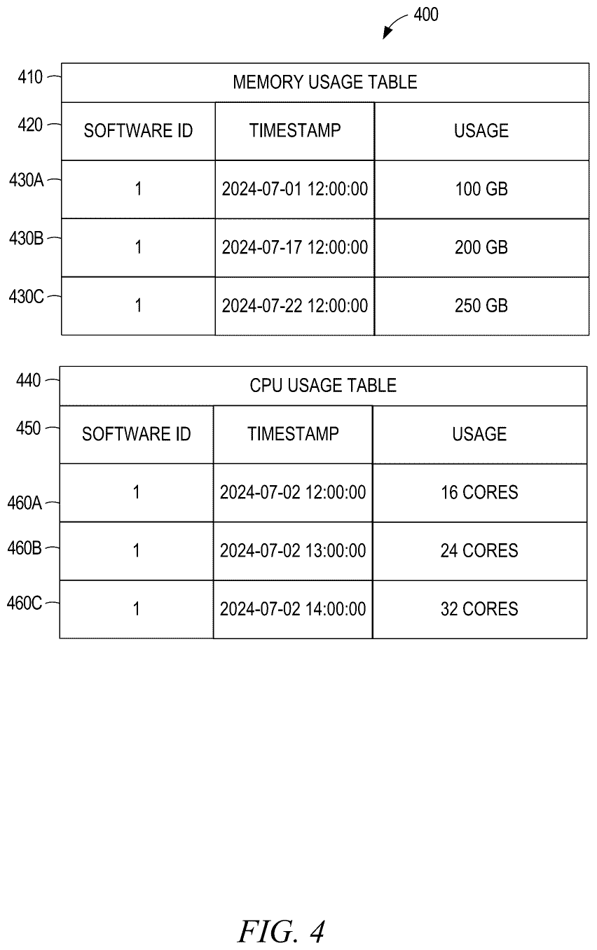

FIG. 4 shows an illustration of an example database schema 400, suitable for training models suitable for forecasting resource usage. The database schema 400 includes a memory usage table 410 and a CPU usage table 440. The memory usage table 410 includes rows 430A, 430B, and 430C of a format 420. The CPU usage table 440 includes rows 460A, 460B, and 460C of a format 450.

Each of the rows 430A-430C of the memory usage table 410 includes an amount of memory used by an application or a database, a unique identifier for the software, and a timestamp that indicates when the memory usage was evaluated, as indicated by the format 420. In the example of FIG. 4, each of the memory usage values is for a single software; however, data may be stored for dozens, hundreds, or thousands of applications or database. The rows 430A-430C show that memory usage has increased from 100 GB on July 1st to 250 GB on July 22nd.

The CPU usage table 440 shows an amount of CPU usage for an application or a database at the indicated timestamp. As with the memory usage table 410, the example of FIG. 4 shows three rows for a single software by way of example only. The rows 460A-460C show that CPU usage has increased from 16 cores to 32 cores from noon on July 2nd to 2 PM on that day.

The memory usage table 410, the CPU usage table 440, or both, may include more or fewer fields than shown in FIG. 4. Example additional fields include: a type of the software, an identifier of an administrator associated with the software, an identifier of a tenant associated with the software, a type of memory being used, or any suitable combination thereof. The database schema 400 may include additional tables to track additional types of resource usage, such as network bandwidth consumed, graphic processing units (GPUs) used, and the like. The memory usage table 410 and the CPU usage table 440 may be combined into a single table that stores multiple usage values for a software and timestamp in a single row.

The historical resource usage data contained in the memory usage table 410 and the CPU usage table 440 may be stored for predetermined periods. For example, the memory usage and CPU usage for each software may be stored at hourly intervals, three-hour intervals, six-hour intervals, twelve-hour intervals, or daily intervals. A time-series algorithm may generate forecasts with the same granularity as the input data. For example, hourly historical data may be used to generate an hourly forecast.

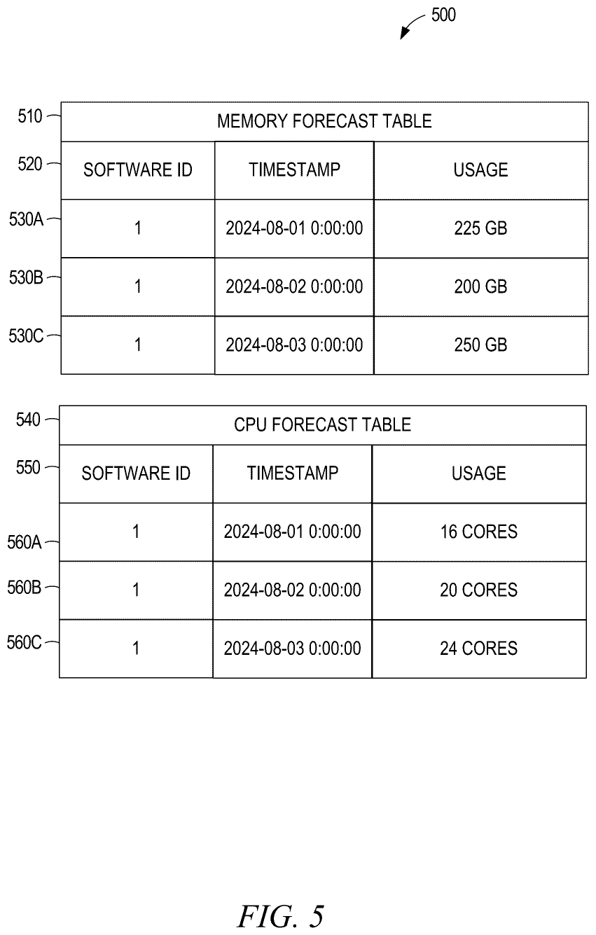

FIG. 5 shows an illustration of an example database schema 500, suitable for storing resource usage forecasts generated using machine learning. The database schema 500 includes a memory forecast table 510 and a CPU forecast table 540. The memory forecast table 510 includes rows 530A, 530B, and 530C of a format 520. The CPU forecast table 540 includes rows 560A, 560B, and 560C of a format 550.

Each of the rows 530A-530C of the memory forecast table 510 includes a unique identifier for a software, a predicted memory usage by the software, and a timestamp that indicates when the software is expected to use the predicted amount of memory, as indicated by the format 520. The CPU forecast table 540 is similar in structure to the memory forecast table 510 except that the forecast data stored is a CPU usage value instead of a memory usage value.

The memory and CPU forecast data may be generated by a machine learning model at a predetermined granularity (e.g., hourly, three-hourly, half-daily, or daily). In the example of FIG. 5, a daily forecast is generated, with the rows 530A and 560A including a forecast for August 1st, the rows 530B and 560B including a forecast for August 2nd, and the rows 530C and 560C including a forecast for August 3rd. In the example of FIG. 5, each of the resource usage forecasts is for the same product. In practice, data for dozens, hundreds, or thousands of software may be stored in the memory forecast table 510 and the CPU forecast table 540.

Additional tables may be included in the database schema 500 to store additional resource forecast values. Alternatively, the memory forecast table 510 and the CPU forecast table 540 may be merged to store all forecast data in a single table.

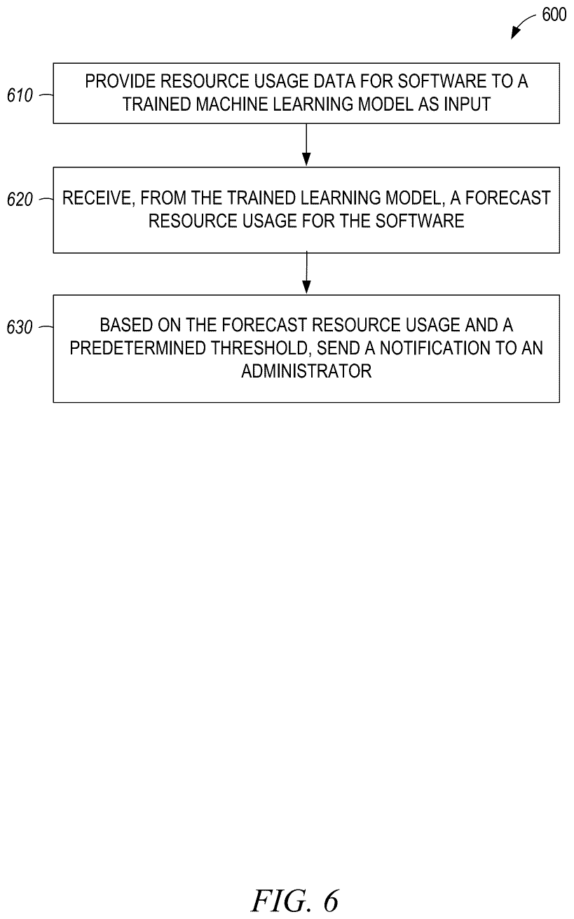

FIG. 6 shows a flowchart illustrating a method 600 of resource usage forecasting using machine learning. The method 600 includes operations 610, 620, and 630. By way of example and not limitation, the method 600 is described as being performed by the forecast server 140 of FIG. 1, using the modules of FIG. 2, the machine learning model of FIG. 3, and the database schemas of FIGS. 4-5.

In operation 610, the forecast server 140 provides resource usage data for software to a trained machine learning model as input. For example, resource usage data for software may be accessed from the memory usage table 410, the CPU usage table 440, or both. The accessed resource usage data may be provided to a trained machine learning model of the forecasting module 240 as input. The resource usage data comprises memory usage data, memory suspension time data, garbage collection count data, instance busy thread data, CPU usage data, network usage data, disk usage data, input/output operations per second (IOPS) data, or any suitable combination thereof.

The forecast server 140 receives, from the trained machine learning model, a forecast resource usage for the software (operation 620). For example, the neural network 320 may generate forecast resource usage data for the software. The trained machine learning model may automatically store the forecast resource usage data for the software in a spreadsheet, and the forecast server 140 may access the resource usage data from the spreadsheet. The forecast server 140 may use the received data to add rows to the memory forecast table 510, the CPU forecast table 540, or both. The forecast resource usage may be for a predetermined period of time. For example, the forecast of resource usage for the software may comprise a three-day forecast, a seven-day forecast, or the like.

In operation 630, based on the forecast resource usage and a predetermined threshold, the forecast server 140 sends a notification to an administrator. For example, an application may be allocated 1 predetermined amount of memory to use, such as 128 GB. If the forecast server 140 determines that the application is predicted to use more than the predetermined amount of memory, an email may be sent to an administrator associated with the application. The notification may include historical usage data, forecast usage data, threshold information, or any suitable combination thereof.

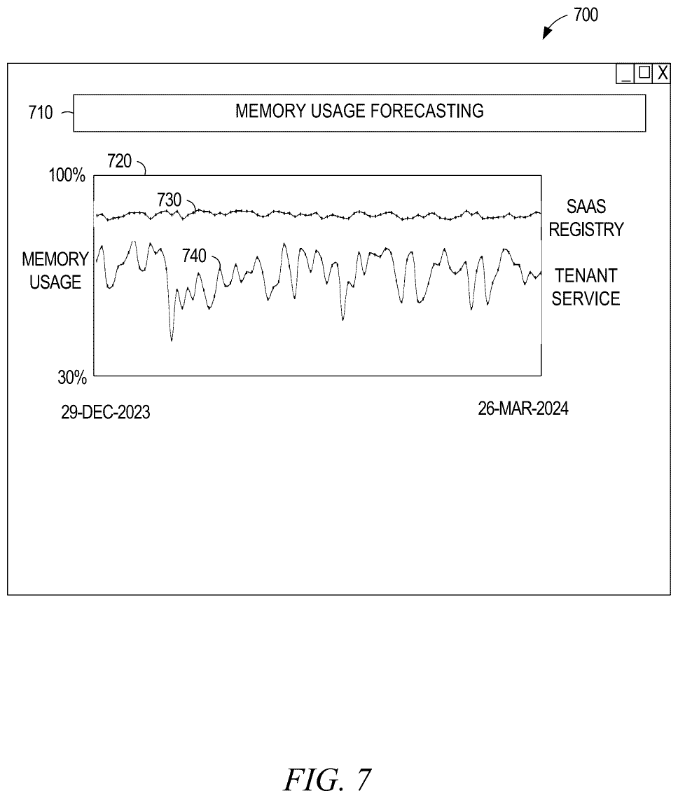

FIG. 7 shows an illustration of an example user interface 700 for displaying resource usage forecasts. The user interface 700 may be generated by the forecast server 140 and presented on a display device of the client device 160A or 160B, all of FIG. 1. The user interface 700 may be presented as part of operation 630 of FIG. 6, in which a notification is provided to an administrator. Alternatively, operation 630 may be performed in another way, such as by sending an email, without use of the user interface 700. The user interface 700 includes a title 710 and an informational area 720. The informational area 720 includes plots 730 and 740.

The title 710 indicates that the user interface 700 includes information regarding memory usage forecasting. The informational area 720 shows information for several applications. The plot 730 shows forecast memory usage for a SAAS registry, and the plot 740 shows forecast memory usage for a tenant service. The y-axis labels show that the forecast memory usage is presented as a percentage of available memory, ranging from 30% to 100%. The x-axis labels show that the date range of the forecast memory usage is from Dec. 29, 2023 to Mar. 26, 2024.

In various example embodiments, more or fewer memory usage forecasts are shown. For example, the date range of the forecast may be longer or shorter (e.g., one week). As another example, a forecast for only one software may be presented, or forecasts for a dozen software may be presented simultaneously.

Variations on the user interface 700 may be used to present other usage forecast data. For example, a CPU usage forecasting interface may be presented to show a forecast number of CPU cores for software. Other examples include network bandwidth usage, garbage collection operations, and the like.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a memory that stores instructions; and one or more processors coupled to the memory and configured to execute the instructions to perform operations comprising: providing resource usage data for software to a trained machine learning model as input; receiving, from the trained machine learning model, a forecast resource usage for the software; and based on the forecast resource usage and a predetermined threshold, sending a notification to an administrator.

In Example 2, the subject matter of Example 1, wherein the operations further comprise: generating the trained machine learning model by providing a training set comprising historical resource usage data for a plurality of applications and databases.

In Example 3, the subject matter of Examples 1-2, wherein the operations further comprise: automatically storing the resource usage data for the software in a spreadsheet; and accessing the resource usage data from the spreadsheet.

In Example 4, the subject matter of Examples 1-3, wherein the software comprises a database.

In Example 5, the subject matter of Examples 1-4, wherein the resource usage data comprises memory usage data, memory suspension time data, garbage collection count data, and instance busy thread data.

In Example 6, the subject matter of Examples 1-5, wherein the resource usage data comprises central processing unit (CPU) usage data, network usage data, disk usage data, and input/output operations per second (IOPS) data.

In Example 7, the subject matter of Examples 1-6, wherein the forecast of resource usage for the software comprises a three-day forecast.

In Example 8, the subject matter of Examples 1-7, wherein the forecast of resource usage for the software comprises a seven-day forecast.

Example 9 is a non-transitory computer-readable medium that stores instructions that, when executed by one or more processors, cause the one or more processors to perform operations comprising: providing resource usage data for software to a trained machine learning model as input; receiving, from the trained machine learning model, a forecast resource usage for the software; and based on the forecast resource usage and a predetermined threshold, sending a notification to an administrator.

In Example 10, the subject matter of Example 9, wherein the operations further comprise: generating the trained machine learning model by providing a training set comprising historical resource usage data for a plurality of applications and databases.

In Example 11, the subject matter of Examples 9-10, wherein the operations further comprise: automatically storing the resource usage data for the software in a spreadsheet; and accessing the resource usage data from the spreadsheet.

In Example 12, the subject matter of Examples 9-11, wherein the software comprises a database.

In Example 13, the subject matter of Examples 9-12, wherein the resource usage data comprises memory usage data, memory suspension time data, garbage collection count data, and instance busy thread data.

In Example 14, the subject matter of Examples 9-13, wherein the resource usage data comprises central processing unit (CPU) usage data, network usage data, disk usage data, and input/output operations per second (IOPS) data.

In Example 15, the subject matter of Examples 9-14, wherein the forecast of resource usage for the software comprises a three-day forecast.

In Example 16, the subject matter of Examples 9-15, wherein the forecast of resource usage for the software comprises a seven-day forecast.

Example 17 is a method comprising: providing, by one or more processors, resource usage data for software to a trained machine learning model as input; receiving, from the trained machine learning model, a forecast resource usage for the software; and based on the forecast resource usage and a predetermined threshold, sending a notification to an administrator.

In Example 18, the subject matter of Example 17 includes generating the trained machine learning model by providing a training set comprising historical resource usage data for a plurality of applications and databases.

In Example 19, the subject matter of Examples 17-18 includes automatically storing the resource usage data for the software in a spreadsheet; and accessing the resource usage data from the spreadsheet.

Example 21 is an apparatus comprising means to implement any of Examples 1-20.

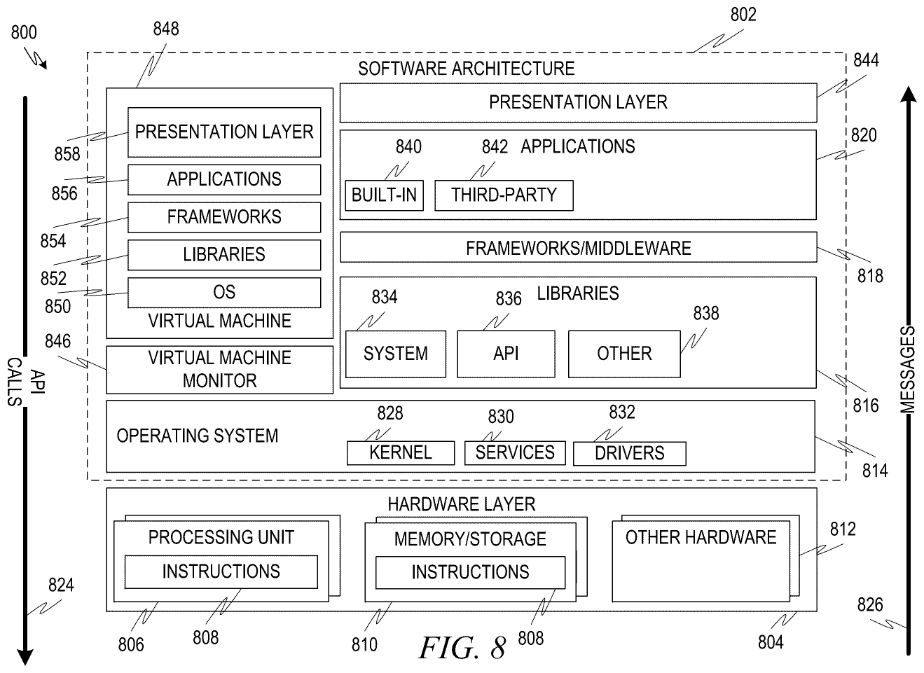

FIG. 8 shows a block diagram 800 showing one example of a software architecture 802 for a computing device. The software architecture 802 may be used in conjunction with various hardware architectures, for example, as described herein. FIG. 8 is merely a non-limiting example of a software architecture, and many other architectures may be implemented to facilitate the functionality described herein. A representative hardware layer 804 is illustrated and can represent, for example, any of the above referenced computing devices. In some examples, the hardware layer 804 may be implemented according to the architecture of the computer system of FIG. 8.

The representative hardware layer 804 comprises one or more processing units 806 having associated executable instructions 808. Executable instructions 808 represent the executable instructions of the software architecture 802, including implementation of the methods, modules, subsystems, and components, and so forth described herein and may also include memory and/or storage modules 810, which also have executable instructions 808. Hardware layer 804 may also comprise other hardware as indicated by other hardware 812 which represents any other hardware of the hardware layer 804, such as the other hardware illustrated as part of the software architecture 802.

In the example architecture of FIG. 8, the software architecture 802 may be conceptualized as a stack of layers where each layer provides particular functionality. For example, the software architecture 802 may include layers such as an operating system 814, libraries 816, frameworks/middleware 818, applications 820, and presentation layer 844. Operationally, the applications 820 and/or other components within the layers may invoke application programming interface (API) calls 824 through the software stack and access a response, returned values, and so forth illustrated as messages 826 in response to the API calls 824. The layers illustrated are representative in nature and not all software architectures have all layers. For example, some mobile or special purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. In some examples, the services 830 include an interrupt service. The interrupt service may detect the receipt of an interrupt and, in response, cause the software architecture 802 to pause its current processing and execute an interrupt service routine (ISR) when an interrupt is accessed.

The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830 and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware 818 may provide a higher-level common infrastructure that may be utilized by the applications 820 and/or other software components/modules. For example, the frameworks/middleware 818 may provide various graphic user interface (GUI) functions, high-level resource management, high-level location services, and so forth. The frameworks/middleware 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 842 may invoke the API calls 824 provided by the mobile operating system such as operating system 814 to facilitate functionality described herein.

The applications 820 may utilize built-in operating system functions (e.g., kernel 828, services 830 and/or drivers 832), libraries (e.g., system libraries 834, API libraries 836, and other libraries 838), and frameworks/middleware 818 to create user interfaces to interact with users of the system. Alternatively, or additionally, in some systems, interactions with a user may occur through a presentation layer, such as presentation layer 844. In these systems, the application/module “logic” can be separated from the aspects of the application/module that interact with a user.

Some software architectures utilize virtual machines. In the example of FIG. 8, this is illustrated by virtual machine 848. A virtual machine creates a software environment where applications/modules can execute as if they were executing on a hardware computing device. A virtual machine is hosted by a host operating system (operating system 814) and typically, although not always, has a virtual machine monitor 846, which manages the operation of the virtual machine 848 as well as the interface with the host operating system (i.e., operating system 814). A software architecture executes within the virtual machine 848 such as an operating system 850, libraries 852, frameworks/middleware 854, applications 856 and/or presentation layer 858. These layers of software architecture executing within the virtual machine 848 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 9 shows a block diagram of a machine in the example form of a computer system 900 within which instructions 924 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation (or cursor control) device 914 (e.g., a mouse), a storage unit 916, a signal generation device 918 (e.g., a speaker), and a network interface device 920.

### Machine-Readable Medium

The storage unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting a machine-readable medium 922.

While the machine-readable medium 922 is shown in FIG. 9 to be a single medium, the term “machine-readable medium” may include a single medium or multiple media (e.g., a centralized or distributed database, and/or associated caches and servers) that store the one or more instructions 924 or data structures. The term “machine-readable medium” shall also be taken to include any tangible medium that is capable of storing, encoding, or carrying instructions 924 for execution by the machine and that cause the machine to perform any one or more of the methodologies of the present disclosure, or that is capable of storing, encoding, or carrying data structures utilized by or associated with the instructions 924. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 924 may further be transmitted or received over a communications network 926 using a transmission medium. The instructions 924 may be transmitted using the network interface device 920 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 924 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
a memory that stores instructions; and
one or more processors coupled to the memory and configured to execute the instructions to perform operations comprising:
providing resource usage data for software to a trained machine learning model as input;
receiving, from the trained machine learning model, a forecast resource usage for the software; and
based on the forecast resource usage and a predetermined threshold, sending a notification to an administrator.

2. The system of claim 1, wherein the operations further comprise:
generating the trained machine learning model by providing a training set comprising historical resource usage data for a plurality of applications and databases.

3. The system of claim 1, wherein the operations further comprise:
automatically storing the resource usage data for the software in a spreadsheet; and
accessing the resource usage data from the spreadsheet.

4. The system of claim 1, wherein the software comprises a database.

5. The system of claim 1, wherein the resource usage data comprises memory usage data, memory suspension time data, garbage collection count data, and instance busy thread data.

6. The system of claim 1, wherein the resource usage data comprises central processing unit (CPU) usage data, network usage data, disk usage data, and input/output operations per second (IOPS) data.

7. The system of claim 1, wherein the forecast of resource usage for the software comprises a three-day forecast.

8. The system of claim 1, wherein the forecast of resource usage for the software comprises a seven-day forecast.

9. A non-transitory computer-readable medium that stores instructions that, when executed by one or more processors, cause the one or more processors to perform operations comprising:
providing resource usage data for software to a trained machine learning model as input;
receiving, from the trained machine learning model, a forecast resource usage for the software; and
based on the forecast resource usage and a predetermined threshold, sending a notification to an administrator.

10. The non-transitory computer-readable medium of claim 9, wherein the operations further comprise:
generating the trained machine learning model by providing a training set comprising historical resource usage data for a plurality of applications and databases.

11. The non-transitory computer-readable medium of claim 9, wherein the operations further comprise:
automatically storing the resource usage data for the software in a spreadsheet; and
accessing the resource usage data from the spreadsheet.

12. The non-transitory computer-readable medium of claim 9, wherein the software comprises a database.

13. The non-transitory computer-readable medium of claim 9, wherein the resource usage data comprises memory usage data, memory suspension time data, garbage collection count data, and instance busy thread data.

14. The non-transitory computer-readable medium of claim 9, wherein the resource usage data comprises central processing unit (CPU) usage data, network usage data, disk usage data, and input/output operations per second (IOPS) data.

15. The non-transitory computer-readable medium of claim 9, wherein the forecast of resource usage for the software comprises a three-day forecast.

16. The non-transitory computer-readable medium of claim 9, wherein the forecast of resource usage for the software comprises a seven-day forecast.

17. A method comprising:
providing, by one or more processors, resource usage data for software to a trained machine learning model as input;
receiving, from the trained machine learning model, a forecast resource usage for the software; and
based on the forecast resource usage and a predetermined threshold, sending a notification to an administrator.

18. The method of claim 17, further comprising:
generating the trained machine learning model by providing a training set comprising historical resource usage data for a plurality of applications and databases.

19. The method of claim 17, further comprising:
automatically storing the resource usage data for the software in a spreadsheet; and
accessing the resource usage data from the spreadsheet.

20. The method of claim 17, wherein the software comprises a database.
